(19) United States
(12) Patent Application Publication
(10) Pub. No.: US 2012/0069716 A1
(43) Pub. Date: Mar. 22, 2012

(54) WEARABLE ELECTRONIC DEVICE WITH WIRELESS COMMUNICATION FUNCTION

(75) Inventor: DA-YI PENG, Tu-Cheng (TW)

(73) Assignee: HON HAI PRECISION INDUSTRY CO., LTD., Tu-Cheng (TW)

(21) Appl. No.: 12/955,910

(22) Filed: Nov. 30, 2010

(30) Foreign Application Priority Data
Sep. 17, 2010 (CN) 201010284973.4

(51) Int. Cl. G06F 1/16; G04B 47/00

(52) U.S. Cl. 368/10; 361/679.03

(57) ABSTRACT

A wearable electronic device includes a processing unit, a housing, and display. The processing unit is inside the housing. The display connected to the processing unit is mounted in the housing. The housing includes a main body and an antenna. The antenna, connected to the processing unit and inlaid in the main body, provides wireless signals to the processing unit.

### BACKGROUND

1. Technical Field

The present disclosure relates to a wearable electronic device with a wireless communication function.

2. Description of Related Art

Electronic devices are now being made small enough to be comfortably worn on a body part such as a wrist. However, when the electronic device has a communication function, an antenna of the electronic device will be positioned inside the electronic device, and often results in poor signal reception and taking up valuable space inside the electronic device.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of a wearable electronic device in accordance with an exemplary embodiment.

FIG. 2 is an exploded view of the wearable electronic device of FIG. 1.

### DETAILED DESCRIPTION

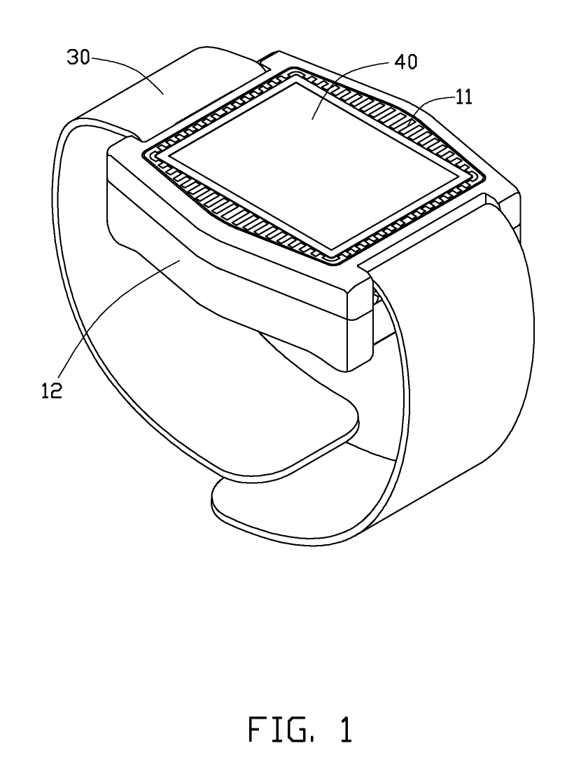

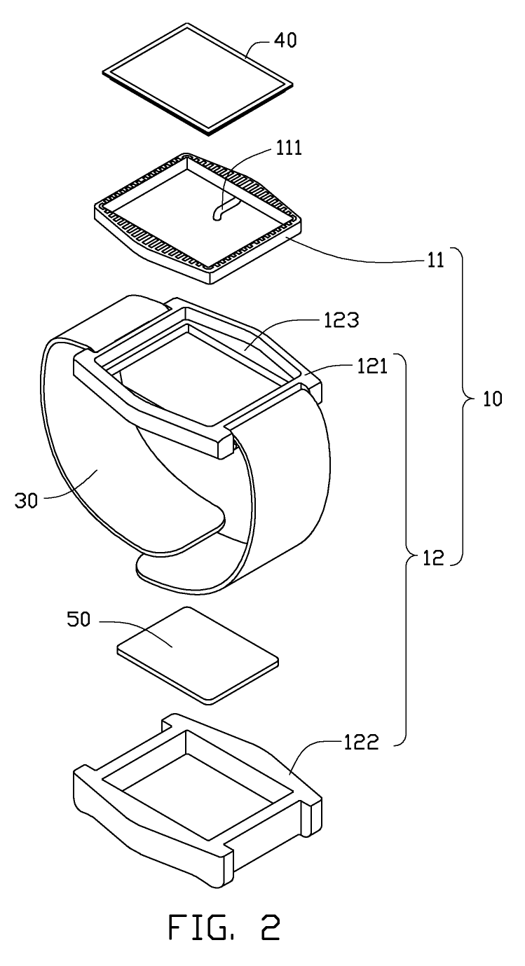

Referring to FIGS. 1 and 2, a wearable electronic device 1 includes a housing 10, a band such as a wrist band 30, a display 40, and a processing unit 50. The housing 10 includes an antenna 11 and a main body 12. The main body 12 includes a supporter 121 and a cover 122. The cover 122 is detachably connected to the supporter 121. The supporter 121 defines a slot 123 that matches the antenna 11. The antenna 11 is inlaid in the slot 123. The antenna 11 is substantially rectangular ring shaped and includes a connecting element 111. The shape of the antenna can be different in other embodiment. The antenna 11 connects to the processing unit 50 through the connecting element 111 and provides wireless signals to the processing unit 50.

The wrist band 30 is fixed to two ends of the supporter 121. The electronic device 1 can be worn on wrist or, using other bands, on the ankle, above the elbow etc. The processing unit 50 is placed inside the housing 10 and connected with the display 40. Signals processed by the processing unit 50 can be displayed on the display 40. The display 40 is mounted in the supporter 121. The antenna 11 encircles the display 40.

In this embodiment, the electronic device 1 can be used as a watch. The display 40 can be used for displaying time. In this embodiment, the housing 10 is made of metal material, such as stainless steel, or tungsten steel. To avoid signal interference caused by the metal housing 10, in this embodiment, the antenna 11 is a ceramic antenna. The ceramic antenna 11 is highly resistant to signal interference from the housing 10. Further the ceramic antenna 11 has the look and feel of metallic and is strong and so can last a long time.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A wearable electronic device comprising:
a processing unit; and
a housing comprising:
a main body; and
an antenna, connected to the processing unit and inlaid in the main body, for providing wireless signals to the processing unit.

2. The electronic device as described in claim 1, further comprising a display, mounted in the housing and encircled by the antenna, for displaying signals processed by the processing unit.

3. The electronic device as described in claim 2, wherein the electronic device is a watch, the display is used for displaying time.

4. The electronic device as described in claim 1, wherein the housing is made of metal material.

5. The electronic device as described in claim 4, wherein the metal is stainless steel or tungsten steel.

6. The electronic device as described in claim 1, wherein the antenna is a ceramic antenna.

7. The electronic device as described in claim 1, further comprising a band, wherein the band is fixed to two ends of the main body.

8. The electronic device as described in claim 1, wherein the main body comprises a supporter and a cover, the cover is detachably connected to the supporter.

9. The electronic device as described in claim 7, wherein the supporter defines a slot that matches the antenna, the antenna is inlaid into the slot.

10. The electronic device as described in claim 1, wherein the antenna is substantially rectangular ring shaped.

11. The electronic device as described in claim 1, wherein the antenna comprises a connecting element, the antenna connects to the processing unit through the connecting element.
